(19) United States
(12) Patent Application Publication
(10) Pub. No.: US 2005/0101772 A1
(43) Pub. Date: May 12, 2005

(54) Non-metallocenes, method for the production thereof and the use thereof for the polymerisation of olefins

(76) Inventors: Jorg Schottek, Frankfurt (DE); Jorg Schulte, Frankfurt (DE); Cornelia Fritze, Frankfurt (DE)

Correspondence Address: Marshall Gerstein & Borun, 6300 Sears Tower, 233 South Wacker Drive, Chicago, IL, 60606-6357, US

(21) Appl. No.: 10/468,180

(22) PCT Filed: Feb. 15, 2002
(86) PCT No.: PCT/EP02/01612

(30) Foreign Application Priority Data
Feb. 17, 2001 (DE) 10107524.3

(51) Int. Cl. C07F 17/00

(52) U.S. Cl. 534/15; 556/52

(57) ABSTRACT

The present invention relates to organometal compounds having a substituted or unsubstituted heterocycle ligand structure. By reaction with metal halides, novel metal complexes, the so-called non-metallocenes, are produced which may be used in the polymerisation of olefins while being integrated in a catalyst system.

The present invention relates to a method for the production of special transition metal compounds, new transition metal compounds and their use for the polymerisation of olefins.

In the last few years, metallocenes—apart from conventional Ziegler catalysts—have been used for the polymerisation of olefin in order to generate polyolefins with special properties which cannot be achieved with conventional Ziegler catalysts. If necessary, metallocenes can be used in combination with one or several co-catalysts as catalyst components for the polymerisation and copolymerisation of olefins. In particular, halogen-containing metallocenes are used as catalyst precursors which may be converted by means of an aluminoxane, for example, into a polymerisation-active cationic metallocene complex.

However, the preparation and use of metallocenes still represents a cost factor nowadays which it has been impossible to overcome either by increased activity or by improved synthesis methods. Moreover, the heterogenisation of such catalysts presents a further problem since, in this case, it is above all the activities which suffer a serious setback compared with homogeneously conducted polymerisation.

In the literature, various “non-metallocenes” are described, e.g. in EP-A 874 005, which are characterised by advantages regarding ease of preparation and the costs of the starting materials. The high activity levels of these complexes represent a further cost saving factor.

In spite of numerous compounds known in the literature, it has not been possible so far to develop “non-metallocenes” which generate isotactic PP with sufficient tacticity.

Consequently, the task existed of developing new metal catalysts which provide new advantageous access to polyolefins, thus avoiding the disadvantages of the state of the art described above.

Surprisingly enough, it has been found that starting out from substituted or unsubstituted heterocyclic substances, a ligand structure can be built up which then provides novel metal complexes by conversion with metal halides. This method of preparation provides universal access to this novel class of compound. The task on which the invention is based is thus solved by way of these compounds.

The subject matter of the present invention consists of compounds of formula (I) 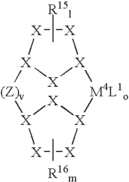
in which
M⁴ is a metal of group III to XII of the periodic system of elements, in particular Ti, Zr, Hf, Ni, V, W, Mn, Rh, Ir, Cu, Co, Fe, Pd, Sc, Cr and Nb
R¹⁵, R¹⁶, respectively, are the same or different and represent a hydrogen atom or Si(R¹²)₃, R¹² representing in the same way or differently a hydrogen atom or a C₁-C₄₀ carbon-containing group such as C₁-C₂₀alkyl, C₁-C₁₀ fluoroalkyl, C₁-C₁₀ alkoxy, C₆-C₂₀ aryl, C₆-C₁₀ fluoroaryl, C₆-C₁₀ aryloxy, C₂-C₁₀ alkenyl, C₇-C₄₀ arylalkyl, C₇-C₄₀ alkylaryl or C₈-C₄₀ arylalkenyl, or R¹⁵, R¹⁶, respectively, are the same or different and represent a C₁-C₃₀ carbon-containing group such as C₁-C₂₅ alkyl, e.g. methyl, ethyl, tert.-butyl, n-hexyl, cyclohexyl or octyl, C₂-C₂₅ alkenyl, C₃-C₁₅ alkylalkenyl, C₆-C₂₄ aryl, C₅-C₂₄ heteroaryl, C₇-C₃₀ arylalkyl, C₇-C₃₀ alkylaryl, fluorine-containing C₁-C₂₅ alkyl, fluorine-containing C₆-C₂₄ aryl, fluorine-containing C₇-C₃₀ arylalkyl, fluorine-containing C₇-C₃₀ alkylaryl or C₁-C₁₂ alkoxy, or two or more R¹⁵ or R¹⁶ radicals may be connected such that the R¹⁵ or R¹⁶ radicals and the atoms of the five-membered ring connecting them form a C₄-C₂₄ ring system which may in turn be substituted,
l may be a number between 0 and 8 for v=0, depending on the valency of the X atom, and a number between 0 and 7 for v=1, depending on the valency of the X atom,
m may be a number between 0 and 8 for v=0, depending on the valency of the X atom, and a number between 0 and 7 for v=1, depending on the valency of the X atom,
X may be the same and different and be an element of groups 13-16 of the periodic system of elements, preferably boron, carbon, silicon, nitrogen, oxygen and sulphur, these forming cyclic systems such as aromatics or aliphatics with each other, in which one or several C atoms may be substituted by N, O, S, B, particularly preferably carbon, sulphur, nitrogen and oxygen which in turn may be substituted by R¹⁵ or R¹⁶, at least one X having to be equal B, Si, N, O, S, P,
L may be the same or different and represent a hydrogen atom, a C₁-C₁₀ hydrocarbon group such as C₁-C₁₀ alkyl or C₆-C₁₀ aryl, a halogen atom or OR⁹, SR⁹, OSi(R⁹)₃, Si(R⁹)₃, P(R⁹)₂ or N(R⁹)₂, in which R⁹ are a halogen atom, a C₁-C₁₀ alkyl group, a halogenated C₁-C₁₀ alkyl group, a C₆-C₂₀ aryl group or a halogenated C₆-C₂₀ aryl group,
o is an integer of 1 to 4, preferably 2,
Z represents a bridging structural element between the two cyclopentadienyl rings and v is 0 or 1.

Examples of Z are the groups M²R¹⁰R¹¹, in which M² is carbon, silicon, germanium, boron or tin and R¹⁰ and R¹¹ represent in the same way or differently a C₁-C₂₀ hydrocarbon-containing group such as C₁-C₁₀ alkyl, C₆-C₁₄ aryl or trimethylsilyl. Preferably, Z is equal CH₂, CH₂CH₂, CH(CH₃)CH₂, CH(C₄H₉)C(CH₃)₂, C(CH₃)₂, (CH₃)₂Si, (CH₃)₂Ge, (CH₃)₂Sn, (C₆H₅)₂Si, (C₆H₅)(CH₃)Si, (C₆H₅)₂Ge, (CH₃)₃Si—Si(CH₃), (C₆H₅)₂Sn, (CH₂)₄Si, CH₂Si(CH₃)₂, o-C₆H₄ or 2,2′-(C₆H₄)₂, as well as 1,2-(1-methyl ethanediyl), 1,2-(1,1-dimethyl ethanediyl) and 1,2-(1,2-dimethyl ethanediyl).

Z may also form a monocyclic or polycyclic ring system with one or several R¹⁵ and/or R¹⁶ radicals.

In the case of the above radicals, Ph represents substituted or unsubstituted phenyl, Et represents ethyl and Me represents methyl.

Particularly preferably, X represents a —CR— radical, R, respectively, representing independently from each other hydrogen or a C₁-C₄₀ carbon-containing group such as C₁-C₂₀ alkyl, such as methyl, ethyl, tert.-butyl, n-hexyl, cyclohexyl or octyl, C₁-C₁₀ fluoroalkyl, C₁-C₁₀ alkoxy, C₆-C₂₄ aryl,-fluorine-containing C₆-C₂₄-Aryl, C₅-C₂₄ heteroaryl, C₆-C₁₀ fluoroaryl, C₆-C₁₀ aryloxy, C₂-C₂₅ alkenyl, C₃-C₁₅ alkylalkenyl, C₇-C₄₀ arylalkyl, fluorine-containing C₇-C₃₀ arylalkyl, C₇-C₄₀ alkylaryl, fluorine-containing C₇-C₃₀ alkylaryl or C₈-C₄₀ arylalkenyl, or two or several R radicals may be connected such that the R radicals and the atoms of the five-membered ring connecting them form a C₄-C₂₄ ring system which in turn may be substituted, with the proviso that at least one X radical is equal B, Si, N, O, S, P.

Preferably, the bridged metal compounds of formula (I), are in particular those in which small v is equal 1 and the five-membered ring is annulated with a six-membered ring.

Bridged organometallic compounds of formula (II) are particularly preferred 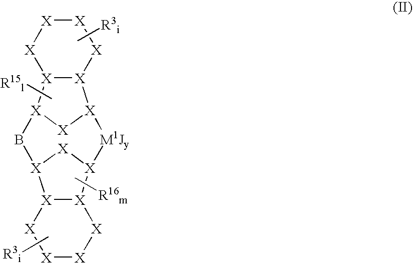
in which
R¹⁵, R¹⁶, X have the above-mentioned meaning,
M¹ is equal Ni, Pd, Co, Fe, Ti, Zr or Hf,
R³ respectively, are the same or different and represent a hydrogen atom, O—Si(R¹²)₃, or Si(R¹²)₃ in which R¹², respectively, represent in the same way or differently a hydrogen atom or a C₁-C₄₀ carbon-containing group such as C₁-C₂₀ alkyl, C₁-C₁₀ fluoroalkyl, C₁-C₁₀ alkoxy, C₆-C₂₀ aryl, C₆-C₁₀ fluoroaryl, C₆-C₁₀ aryloxy, C₂-C₁₀ alkenyl, C₇-C₄₀ arylalkyl, C₇-C₄₀ alkylaryl or C₈-C₄₀ arylalkenyl

or R³, respectively, are the same or different and represent a C₁-C₃₀ carbon-containing group such as C₁-C₂₅ alkyl, e.g. methyl, ethyl, tert.-butyl, n-hexyl, cyclohexyl or octyl, C₂-C₂₅ alkenyl, C₃-C₁₅ alkylalkenyl, C₆-C₂₄ aryl, C₅-C₂₄ heteroaryl, C₇-C₃₀ arylalkyl, C₇-C₃₀ alkylaryl, fluorine-containing C₁-C₂₅-Alkyl, fluorine-containing C₆-C₂₄-Aryl, fluorine-containing C₇-C₃₀-Arylalkyl, fluorine-containing C₇-C₃₀ alkylaryl-or C₁-C₁₂ alkoxy or two or more R³ radicals may be connected such that the R³ radicals and the atoms connecting them form a C₄-C₂₄ ring system which in turn may be substituted,
J is, independently from each other, a halogen atom, in particular chlorine, alkyl groups, C₁-C₁₈ alkyl group, in particular methyl, ethyl, tert.-butyl or substituted or unsubstituted phenolates,
i respectively, represent in the same way or differently an integer between 1 and 8, preferably 2 bis 4, particularly preferably equal 4, depending on the valency of the X atom,
B represents a bridging structural element between the two cyclic systems,
l is an integer of 1 to 5, preferably 1 to 3, depending on the valency of the X atom,
m is an integer of 1 to 5, preferably 1 to 3, depending on the valency of the X atom,
y is an integer of 1 to 4, preferably 2.

The ring system is preferably substituted by R³, R¹⁵ or R¹⁶, in particular in 2, 4, 7, 2, 4, 5, 2, 4, 6, 2, 4, 7, 2, 4, 5, 6, 7 or 2, 4, 5, 6, with C₁-C₂₀ carbon-containing groups such as e C₁-C₁₈ alkyl or C₆-C₁₈ aryl, two or more constituents of the cyclic system together being capable of forming a ring system.

Examples of B are the groups M³R¹³R¹⁴, in which M³ is silicon or carbon and R¹³ and R¹⁴ represent in the same way hydrocarbon-containing groups such-as C₁-C₁₀ alkyl, C₆-C₁₄ aryl or trimethylsilyl. Preferably, B is equal CH₂, CH₂CH₂, CH(CH₃)CH₂, CH(C₄H₉)C(CH₃)₂, C(CH₃)₂, (CH₃)₂Si, (CH₃)₃Si—Si(CH₃). In the above radicals, Ph represents substituted or unsubstituted phenyl, Et represents ethyl and Me represents methyl.

Particularly preferable are bridged metal compounds of formula (II) in which
M¹ is equal Ni, Co, Fe Ti or Zr,
R¹⁵, R¹⁶, respectively, represent a hydrogen atom or a linear or branched C₁-C₁₂ alkyl group, preferably an alkyl group such as methyl, ethyl, n-butyl, n-hexyl, isopropyl, isobutyl, isopentyl, cyclohexyl, cyclopentyl or octyl, particularly preferably methyl ethyl, isopropyl or cyclohexyl,
R³ respectively, are the same or different and represent a hydrogen atom, halogen atom or a C₁-C₂₀ carbon-containing group, preferably a linear or branched C₁-C₈ alkyl group such as methyl, ethyl, tert.-butyl, cyclohexyl or octyl, C₂-C₆ alkenyl, C₃-C₆ alkylalkenyl, a C₆-C₁₈ aryl group, which, if necessary may be substituted, in particular phenyl, tolyl, xylyl, tert.-butylphenyl, ethylphenyl, naphthyl, acenaphthyl, phenanthrenyl or anthracenyl, C₅-C₁₈ heteroaryl, C₇-C₁₂ arylalkyl, C₇-C₁₂ alkylaryl, fluorine-containing C₁-C₈ alkyl, fluorine-containing C₆-C₁₈ aryl, fluorine-containing C₇-C₁₂ arylalkyl or fluorine-containing C₇-C₁₂ alkylaryl,
J is chlorine or methyl,
X respectively, may be the same and different and represent carbon, nitrogen, oxygen, boron and sulphur, forming, among each other, cyclic systems such as aromatics or aliphatics in which one or several C atoms may be substituted by N, O, S, B, in particular carbon, nitrogen and oxygen which in turn may be substituted by R¹⁵, R¹⁶ or R³, at least one X having to be equal B, Si, N, O, S, P,
i are in the same way or differently an integer between 3 and 4, preferably equal 4, depending on the valency of the X atom,
l is equal 1 or 2, depending on the valency of the X atom,
m is equal 1 or 2, depending on the-valency of the X atom,
B represents a bridging structural element between the cyclic systems, B being preferably equal Si(Me)₂, Si(Ph)₂, Si(Et)₂, Si(MePh), CH₂, CH₂CH₂, (CH₃)₃Si—Si(CH₃).

In the above radicals, Ph represents substituted or unsubstituted phenyl, Et represents ethyl and Me represents methyl.
y is an integer of 1 to 4, preferably 2,

Explanatory, though non-restricting examples of the compounds according to the invention of formula (II) are:
(B)bis-(N,N′-pyrazolyl)nickel dibromide
(B)bis-(N,N′-3,5-dimethylpyrazolyl)nickel dibromide
(B)bis-(N,N′-imidazolyl)nickel dibromide
Bis-(imidazolyl)nickel dibromide
(B)bis-(N,N′-indazolyl)nickel dibromide
(B)bis -(N,N′-indolyl)nickel dibromide
Bis-(isothiazolyl)nickel dibromide
(B)bis-(N,N′-purinyl)nickel dibromide
(B)bis-(N,N′-triazolyl)nickel dibromide
(B)bis-(N,N′-2-methylbenzimidazolyl)nickel dibromide
(B)bis-(N,N′-pyrazolyl)iron dichloride
(B)bis-(N,N′pyrazolyl-4-phenyl)nickel dibromide
(B)bis-(N,N′-3, 5-dimethylpyrazolyl-4-phenyl)nickel dibromide
(B)bis-(N,N′-imidazolyl-4-phenyl)nickel dibromide
(B)bis-(N,N′-indazolyl-4-phenyl)nickel dibromide
(B)bis-(N-indolyl-4-phenyl)nickel dibromide
Bis-(isothiazolyl-4-phenyl)nickel dibromide
(B)bis-(N,N′-purinyl-4-phenyl)nickel dibromide
(B)bis-(N,N′-triazolyl-4-phenyl)nickel dibromide
(B)bis-(N,N′-2-methylbenzimidazolyl-4-phenyl)nickel dibromide
(B)bis-(N,N′-pyrazolyl-4-(4′-tert.-butyl-phenyl))nickel dibromide
(B)bis-(N,N′-3,5-dimethylpyrazolyl-4-(4′-tert.-butyl-phenyl))nickel dibromide
(B)bis-(N,N′-imidazolyl-4-(4′-tert.-butyl,-phenyl))nickel dibromide
(B)bis-(N,N′-indazolyl-4-(4′-tert.-butyl-phenyl))nickel dibromide
(B)bis-(N-indolyl-4-(4′-tert.-butyl-phenyl))nickel dibromide
(B)bis-(isothiazolyl-4-(4′-tert.-butyl-phenyl))nickel dibromide
(B)bis-(N,N′-purinyl-4-(4′-tert.-butyl-phenyl))nickel dibromide
(B)bis-(N,N′-triazolyl-4-(4′-tert.-butyl-phenyl))nickel dibromide
(B)bis-(N,N′-2-methylbenzimidazolyl-4-(4′-tert.-butyl-phenyl))nickel dibromide
(B)bis-(N,N′-pyrazolyl-4-naphthyl)nickel dibromide
(B)bis-(N,N′-3,5-dimethylpyrazolyl-4-naphthyl)nickel dibromide
(B)bis-(N,N′-imidazolyl-4-naphthyl)nickel-dibromide
(B)bis-(N,N′-indazolyl-4-naphthyl)nickel dibromide
(B)bis-(N,N′-indolyl-4-naphthyl)nickel dibromide
(B)bis-(isothiazolyl-4-naphthyl)nickel dibromide
(B)bis-(N,N′-purinyl-4-naphthyl)nickel dibromide
(B)bis-(N,N′-triazolyl-4-naphthyl)nickel dibromide
(B)bis-(N,N′-2-methylbenzimidazolyl-4-naphthyl)nickel dibromide
(B)bis-(N,N′-pyrazolyl)iron dichloride
(B)bis-(N,N′-3,5-dimethylpyrazolyl)iron dichloride
(B)bis-(N,N′-imidazolyl)iron dichloride
(B)bis-(N,N′-indazolyl)iron dichloride
(B)bis-(N,N′-indolyl)iron dichloride
Bis-(isothiazolyl)iron dichloride
(B)bis-(N,N′-purinyl)iron dichloride
(B)bis-(N,N′-triazolyl)iron dichloride
(B)bis-(N,N′-2-methylbenzimidazolyl)iron dichloride
(B)bis-(N,N′-benzimidazolyl)nickel dibromide
(B)bis-(N,N′-benzimidazolyl)iron dichloride
(B)bis-(N,N′-benzimidazolyl)palladium dichloride
Bis-(imidazolyl)zirconium dichloride
Bis-(imidazolyl)titanium dichloride
Bis-(imidazolyl)hafnium dichloride
Bis-(benzimidazolyl)zirconium dichloride
Bis-(benzimidazolyl)titanium dichloride
Bis-(benzimidazolyl)hafnium dichloride
(B)bis-(N,N′-2,3-dihydro-1H-benzimidazolyl)zirconium dichloride
(B)bis-(N,N′-2,3-dihydro-1H-benzimidazolyl)titanium dichloride
(B)bis-(N,N′-2,3-dihydro-1H-benzimidazolyl)hafnium dichloride
(B)bis-(N,N′-2,3-dihydro-2,2-dimethyl-1H-benzimidazolyl)zirconium dichloride
(B)bis-(N,N′-2,3-dihydro-2,2-dimethyl-1H-benzimidazolyl)titanium dichloride
(B)bis-(N,N′-2,3-dihydro-2,2-dimethyl-1H-benzimidazolyl)hafnium dichloride

Explanatory though non-restricting examples of B are: Si(Me)₂, Si(Ph)₂, Si(Et)₂, Si(MePh), Si(C₄H₈), CH₂, CMe₂, CHMe, CH₂CH₂, (CH₃)₃Si—Si(CH₃).

The present invention also relates to a catalyst system which contains the chemical compound of formula (II) according to the invention.

The metal complexes of formula (II) according to the invention are particularly suitable as components of catalyst systems for the production of polyolefins by the polymerisation of at least one olefin in the presence of a catalyst which contains at least one co-catalyst and at least one metal complex.

The co-catalyst which forms -the catalyst system together with a transition metal complex of formula II according to the invention contains at least one compound of the type of an aluminoxan or a Lewis acid or an ionic compound which, by reaction with a metal complex, converts it into a cationic compound.

A compound with the general formula (III)
(R AlO)ₙ (III)
is preferably used as aluminoxane.

Other suitable aluminoxanes may, for example, be cyclic as in formula (IV) 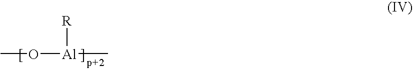
or linear as in formula (V) 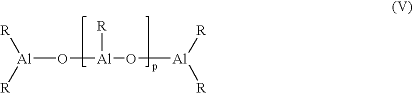
or of the cluster type as in formula (VI).

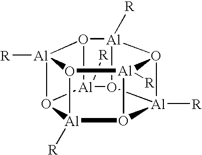

Such aluminoxanes are described in JACS 117 (1995), 6465-74, Organometallics 13 (1994), 2957-2969, for example.

The R radicals in formulae (III), (IV), (V) and (VI) may be the same or different and represent a C₁-C₂₀ hydrocarbon group such as a C₁-C₆ alkyl group, a C₆-C₁₈ aryl group, benzyl or hydrogen and p may represent an integer of 2 to 50, preferably 10 to 35.

Preferably, the R radicals are the same and represent methyl, isobutyl, n-butyl, phenyl or benzyl, particularly preferably methyl.

If the R radicals differ from each other, they are preferably methyl and hydrogen, methyl and isobutyl or methyl and n-butyl, hydrogen and/or isobutyl or n-butyl being preferably present in an amount of 0.01-40% (number of R radicals).

The aluminoxane may be produced in different ways according to known processes. One of the methods involves, for example, reacting an aluminium hydrocarbon compound and/or a hydridoaluminium hydrocarbon compound with water (gaseous, solid, liquid or combined—for example as water of crystallisation) in an inert solvent (such as e.g. toluene).

For the production of an aluminoxane with different R alkyl groups, two different aluminium trialkyls (AlR₃+AlR′₃), depending on the desired composition and reactivity, are reacted with water (compare S. Pasynkiewicz, Polyhedron 9 (1990) 429 and EP-A-0 302 424).

Irrespective of the type of production, all aluminoxane solutions have the common feature of a changing content of unreacted aluminium starting compound which is present in the free form or as an adduct.

Preferably, at least one organoboron or organoaluminium compound is used as Lewis acid, which contain C₁-C₂₀ carbon-containing groups such as branched or unbranched alkyl or halogenalkyl, such as e.g. methyl, propyl, isopropyl, isobutyl, trifluoromethyl, unsaturated groups such as aryl or halogen aryl such as phenyl, toluyl, benzyl groups, p-fluorophenyl, 3,5-difluorophenyl, pentachlorophenyl, pentafluorophenyl, 3,4,5 trifluorophenyl and 3,5 di(trifluoromethyl)phenyl.

Examples of Lewis acids are trimethylaluminium, triethylaluminium, triisobutylaluminium, tributylaluminium, trifluoroborane, triphenylborane, tris(4-fluorophenyl)borane, tris(3,5-difluorophenyl)borane, tris(4-fluoromethylphenyl)borane, tris(pentafluorophenyl)borane, tris(tolyl)borane, tris(3,5-dimethylphenyl)borane, tris(3,5-difluorophenyl)borane and/or tris(3,4,5-trifluorophenyl)borane. Tris(pentafluorophenyl)borane is particularly preferred.

Preferably, compounds are used as ionic co-catalysts which contain a non-co-ordinated anion such as, for example, tetrakis(pentafluorophenyl)borates, tetraphenylborates, SbF₆—, CF₃SO₃— or ClO₄—. Protonated Lewis bases are used as cationic counter-ions such as e.g. methylamine, aniline, N,N-dimethylbenzylamine and derivatives, N,N-dimethylcyclohexylamine and the derivatives, dimethylamine, diethylamine, N-methylaniline, diphenylamine, N,N-dimethylaniline, trimethylamine, triethylamine, tri-n-butylamine, methyldiphenylamine, pyridine, p-bromo-N,N-dimethylaniline, p-nitro-N,N-dimethylaniline, triethylphosphine, triphenylphosphine, diphenylphosphine, tetrahydrothiophene or triphenylcarbenium.

Examples of such ionic compounds are
triethylammonium tetra(phenyl)borate,
tributylammonium tetra(phenyl)borate,
trimethylammonium tetra(tolyl)borate,
tributylammonium tetra(tolyl)borate,
tributylammonium tetra(pentafluorophenyl)borate,
tributylammonium tetra(pentafluorophenyl)aluminate,
tripropylammonium tetra(dimethylphenyl)borate,
tributylammonium tetra(trifluoromethylphenyl)borate,
tributylammonium tetra(4-fluorophenyl)borate,
N,N-dimethylanilinium tetra(phenyl)borate,
N,N-diethylanilinium tetra(phenyl)borate,
N,N-dimethylanilinium tetrakis(pentafluorophenyl)borate,
N,N-dimethylanilinium tetrakis(pentafluorophenyl)aluminate,
N,N-dimethylcyclohexylammonium tetrakis(pentafluorophenyl)borate,
N,N-dimethylbenzylammonium tetrakis(pentafluorophenyl)borate,
di(propyl)ammonium tetrakis(pentafluorophenyl)borate,
di(cyclohexyl)ammonium tetrakis(pentafluorophenyl)borate,
triphenylphosphonium tetrakis(phenyl)borate,
triethylphosphonium tetrakis(phenyl)borate,
diphenylphosphonium tetrakis(phenyl)borate,
tri(methylphenyl)phosphonium tetrakis(phenyl)borate,
tri(dimethylphenyl)phosphonium tetrakis(phenyl)borate,
triphenylcarbenium tetrakis(pentafluorophenyl)borate,
triphenylcarbenium tetrakis(pentafluorophenyl)aluminate,
triphenylcarbenium tetrakis(phenyl)aluminate,
ferrocenium tetrakis(pentafluorophenyl)borate and/or
ferrocenium tetrakis(pentafluorophenyl)aluminate.

Triphenylcarbenium tetrakis(pentafluorophenyl)borate and/or N,N-dimethylanilinium tetrakis(pentafluorophenyl)borate are preferred. Mixtures of at least one Lewis acid and at least one ionic compound may also be used.

Borane or caborane compounds such as e.g. 7,8-dicarbaundecaborane(13), undecahydride-7,8-dimethyl-7,8-dicarbaundecaborane, dodecahydride-1 -phenyl-1 ,3-dicarbanonaborane, tri(butyl)ammonium undecahydride-8-ethyl-7,9-dicarbaundecaborate, 4-carbanonaborane(14)bis(tri(butyl)ammonium)nonaborate, bis(tri(butyl)ammonium) undecaborate, bis(tri(butyl)ammonium) dodecaborate, bis(tri(butyl)ammonium) decachlorodecaborate, tri(butyl)ammonium-1-carbadecaborate, tri(butyl)ammonium-1-carbadodecaborate, tri(butyl)ammonium-1-trimethylsilyl-1-carbadecaborate, tri(butyl)ammoniumbis(nonahydride-1,3-dicarbonnonaborate) cobaltate(iii), tri(butyl)ammoniumbis(undecahydride-7,8-dicarbaundecaborate) ferrate(III) are also important as co-catalyst components.

Combinations of at least one of the above-mentioned amines and, optionally, a carrier with organoelement compounds, as described in the patent WO 99/40129, are also important as co-catalysts systems. The carriers with organoelement compounds mentioned in WO 99/40129 form also part of the present invention.

A preferred component of these co-catalyst systems consists of the compounds of formulae (A) and (B), 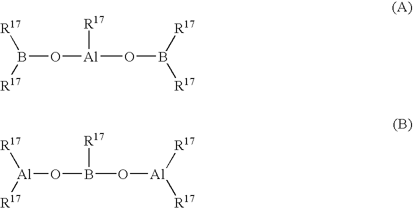
in which
R¹⁷ respectively, represents in the same way or differently a hydrogen atom, a halogen atom, a C₁-C₄₀ carbon-containing group, in particular C₁-C₂₀ alkyl, C₁-C₂₀ halogen alkyl, C₁-C₁₀ alkoxy, C₆-C₂₀ aryl, C₆-C₂₀ halogen aryl, C₆-C₂₀ aryloxy, C₇-C₄₀ arylalkyl, C₇-C₄₀ halogen arylalkyl, C₇-C₄₀ alkylaryl or C₇-C₄₀ halogen alkylaryl. R¹⁷ may also be an —OSiR¹⁸₃ group in which R¹⁶, respectively, may be the same or different and has the same meaning as R¹⁷.

In addition, those compounds should be regarded as further preferred co-catalysts in general which are formed by the reaction of at least on compound of formula (C) and/or (D) and/or (E) with at least one compound of formula (F).
R¹⁷ᵥB—(DR⁸⁰)ₛ (C)
R¹⁷₂B—X¹—BR ¹⁷₂ (D)

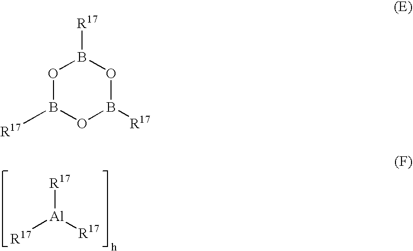

in which
R⁸⁰ respectively, may represent in the same way or differently a hydrogen atom or a boron-free C₁-C₄₀ carbon-containing group such as C₁-C₂₀ alkyl, C₆-C₂₀ aryl, C₇-C₄₀ arylalky, C₇-C₄₀ alkylaryl and in which
R¹⁷ has the same meaning as mentioned above,
X¹ is equal to an element of the main group VI of the periodic system of elements or an NR group in which R is a hydrogen atom or a C₁-C₂₀ hydrocarbon radical such as C₁-C₂₀ alkyl or C₁-C₂₀ aryl,
D is equal to an element of the main group VI of the periodic system of elements or an NR group in which R is a hydrogen atom or a C₁-C₂₀ hydrocarbon radical such as C₁-C₂₀ alkyl or C₁-C₂₀ aryl,
v is an integer of 0 to 3
s is an integer of 0 to 3,
h is an integer of 1 to 10,
B is boron,
Al is aluminium.

If necessary, the organoelement compounds are combined with an organometal compound of formula II to V and/or VII [M40R19b]d in which M40 is an element of the main groups I, II and III of the periodic system of elements, R19 is the same or different and represents a hydrogen atom, a halogen atom, a C1-C40 carbon-containing group, in particular C1-C20 alkyl-, C6-C40 aryl-, C7-C40 arylalkyl or C7-C40 alkylaryl group, b is an integer of 1 to 3 and d is an integer of 1 to 4.

Examples of compounds of formula A and B with a co-catalytic effect are

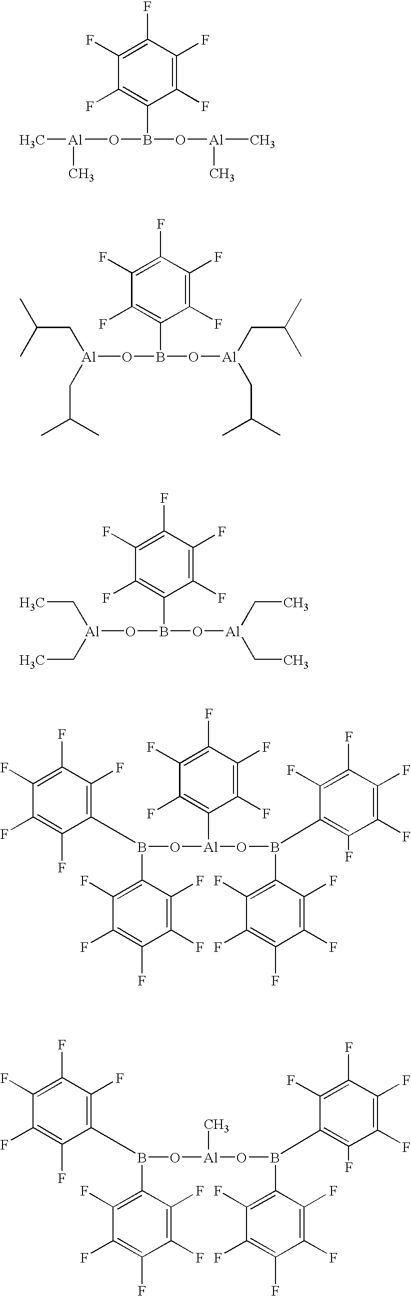

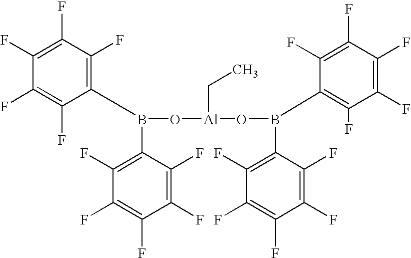

The organometal compounds of formula VII are preferably neutral Lewis acids in which M⁴⁰ represents lithium, magnesium and/or aluminium, in particular aluminium. Examples of the preferred organometal compounds of formula XII are trimethylaluminium, triethylaluminium, triisopropylaluminium, trihexylaluminium, trioctylalumirnium, tri-n-butylaluminium, tri-n-propylaluminium, triisoprenaluminium, dimethylaluminium monochloride, diethylaluminium monochioride, disobutylaluminium monochloride, methylaluminium sesquichloride, ethylaluminium sesquichloride, dimethylaluminium hydride, diethylaluminium hydride, diisopropylaluminium hydride, dimethylaluminium (trimethylsiloxide), dimethylaluminium (triethylsiloxide), phenyl alane, pentafluorophenyl alane and o-tolyl alane.

The compounds mentioned in EP-A-924223, DE-A-19622207, EP-A-601830, EP-A-824112, EP-A-824113, EP-A-811627, WO97/11775 and DE-A-19606167 may be used as further co-catalysts which may be non-carrier-supported or carrier-supported.

The carrier component of the catalyst system according to the invention may be any desired organic or inorganic, inert solid, in particular a porous carrier such as talcum, inorganic oxides and finely divided polymer powder (e.g. polyolefins).

Suitable inorganic oxides may be found in the main group II-VI of the periodic system and the sub-group III-IV of the periodic system of elements. Examples of oxides which are preferred as carrier include silicon dioxide, aluminium oxide and mixed oxides of the elements calcium, aluminium, silicon, magnesium, titanium and the corresponding oxide mixtures as well as hydrotalcites. Other inorganic oxides which may be used alone or in combination with the preferred oxide carriers last mentioned are e.g. MgO, ZrO₂ , TiO₂ or B₂O₃, to mention just a few.

The carrier materials used have a specific surface area in the region of 10 to 1000 m²/g, a pore volume in the region of 0.1 to 5 ml/g and an average particle size of 1 to 500 μm. Carriers with a specific surface area in the region of 50 to 500 μm, a pore volume in the region of between 0.5 and 3.5 ml/g and an average particle size in the region of 5 to 350 μm are preferred. Carriers with a specific surface area in the region of 200 to 400 m²/g, a pore volume in the region of between 0.8 and 3.0 ml/g and an average particle size of 10 to 200 μm are particularly preferred.

If the carrier material used has an inherently low moisture content or residual solvent content, dehydration or drying may be omitted before use. If this is not the case, e.g. when using silica gel as carrier material, dehydration or drying is recommended. Thermal dehydration or drying of the carrier material may take place under vacuum with simultaneous blanketing with inert gas (e.g. nitrogen). The drying temperature is in region between 100 and 1000° C., preferably between 200 and 800° C. The pressure parameter is not of decisive importance in this case. The duration of the drying process may be between 1 and 24 hours. Shorter or longer drying periods are possible provided that the equilibrium adjustment with the hydroxyl groups on the carrier surface may take place under the conditions chosen; normally, this requires 4 to 8 hours.

Dehydration or drying of the carrier material is also possible by the chemical route by causing the adsorbed water and the hydroxyl groups on the surface to react with suitable inertisation agents. By reaction with the inertisation reagent, the hydroxyl groups may be converted completely or partially into a form which does not lead to a negative interaction with the catalytically active centres. Suitable inertisation agents are, for example, silicon halides and silanes, such as silicon tetrachloride, chlorotrimethylsilane, dimethylaminotrichlorosilane or organometal compounds of aluminium, boron and magnesium such as, for example, trimethylaluminium, triethylaluminium, triisobutylaluminium, triethylborane, dibutylmagnesium. As an example, the chemical dehydration or inertisation of the carrier material takes place by causing a suspension of the carrier material in a suitable solvent to react, with the exclusion of air and moisture, with the inertisation reagent in the pure form or dissolved in a suitable solvent. Suitable solvents are, for example, aliphatic or aromatic hydrocarbons such as pentane, hexane, heptane, toluene or xylene. The inertisation takes places at temperatures between 25° C. and 120° C., preferably between 50 and 70° C. Higher and lower temperatures are possible. The duration of the reaction is between 30 minutes and 20 hours, preferable 1 to 5 hours. On completion of the chemical dehydration process, the carrier material is isolated by filtration under inert conditions, washed once or several times with suitable inert solvents such as those already described above and subsequently dried in a stream of inert gas or under vacuum.

Organic carrier materials such as finely divided polyolefin powders (e.g. polyethylene, polypropylene or polystyrene) may also be used and should also be freed from adhering moisture, solvent residues or other impurities, before use, by corresponding cleaning and drying operations.

For the preparation of the carrier-supported system, at least one of the transition metal compounds of formula II described above is brought into contact, in a suitable solvent, with a least one co-catalyst component, a soluble reaction product, an adduct or an mixture preferably being obtained.

The preparation thus obtained is then mixed with the carrier material which is dehydrated or rendered inert, the solvent is removed and the resulting carrier-supported transition metal compound catalyst system is dried in order to ensure that the solvent is completely or largely removed from the pores of the carrier material. The carrier-supported catalyst is obtained as a free flowing powder.

A process for the preparation of a free-flowing and, if necessary, prepolymerised transition metal compound catalyst system comprises the following steps:
a) Preparation of a transition metal compound/co-catalyst mixture in a suitable solvent or suspension agent, the transition metal compound component having one of the structures described above
b) Applying the transition metal compound/co-catalyst mixture onto a porous, preferably inorganic dehydrated carrier
c) Removing the main part of the solvent from the resulting mixture
d) Isolating the carrier-supported catalyst system
e) If necessary, prepolymerisation of the carrier-supported catalyst system thus obtained with one or several olefinic monomer(s) in order to obtain a prepolymerised carrier-supported catalyst system.

Preferred solvents for the production of the transition metal compound/co-catalyst mixture are hydrocarbons and hydrocarbon mixtures which are liquid at the reaction temperature selected and in which the individual components preferably dissolve. However, the solubility of the individual components is not a precondition, provided it is ensured that the reaction product of transition metal compound and co-catalyst components is soluble in the solvent chosen. Examples of solvents comprise alkanes such as pentane, isopentane, hexane, heptane, octane and nonane; cycloalkanes such as cyclopentane and cyclohexane; and aromatics such as benzene, toluene, ethylbenzene and diethylbenzene. Toluene is particularly preferred.

The quantities of aluminoxane and transition metal compound used for the preparation of the carrier-supported catalyst system may vary within a wide range. Preferably, a molar ratio of aluminium to transition metal of 10:1 to 1000:1, particularly preferably a ratio 50:1 to 500:1 is adjusted in the transition metal compounds.

In the case of methylaluminoxane, 30% strength toluinic solutions are preferably used; however, using 10% solutions is also possible

For the preliminary activation, the transition metal compound is dissolved in the form of a solid in a solution of the aluminoxane in a suitable solvent. It is also possible to dissolve the transition metal compound separately in a suitable solvent and to combine this solution subsequently with the aluminoxane solution. Preferably, toluene is used.

The preliminary activation time is 1 minute to 200 hours.

The preliminary activation may take place at room temperature (25° C.). Using higher temperatures may shorten the duration of the preliminary activation in individual cases-and cause an additional increase in activity. In this case, higher temperatures means a region between 50 and 100° C.

The preactivated solution and/or the transition metal compounds/co-catalyst mixture is subsequently combined with an inert carrier material, usually silica gel, which is present in the form of a dry powder or as a suspension in one of the solvents mentioned above. Preferably, the carrier material is, used as a powder. The sequence of addition is arbitrary. The preactivated transition metal compound-co-catalyst solution and/or the transition metal compound-co-catalyst mixture may be metered into the carrier material provided or the carrier material may be introduced into the solution provided.

The volume of the preactivated solution and/or the transition metal compound-co-catalyst mixture may exceed 100% of the total pore volume of the carrier material used or it may amount to up to 100% of the total pore volume.

The temperature at which the preactivated solution or the transition metal compound-co-catalyst mixture is brought into contact with the carrier material may vary within the region of 0 and 100° C. However, lower or higher temperatures are also possible.

Subsequently, the solvent is removed completely or largely from the carrier-supported catalyst system, the mixture being stirred and if necessary heated. Preferably, both the visible portion of the solvent and the portion in the pores of the carrier material are removed. The removal of the solvent may take place in a conventional manner using vacuum and/or flushing with inert gas. During the drying process, the mixture may be heated until the free solvent has been removed; usually, this requires 1 to 3 hours at a temperature preferably chosen between 30 and 60° C. The free solvent is the visible portion of solvent in the mixture. Residual solvent should be understood to mean the portion which is enclosed in the pores. As an alternative to the complete removal of the solvent, the carrier-supported catalyst system may also be dried merely up to a certain residual solvent content, the free solvent being completely removed. Subsequently; the carrier-supported catalyst system is washed with a low boiling hydrocarbon such as pentane or hexane and dried once more.

The carrier-supported catalyst system prepared according to the invention may be used either directly for the polymerisation of olefins or be prepolymerised before its use in a polymerisation process with one or several olefinic monomers. The execution of the prepolymerisation of carrier-supported catalyst systems is described in WO 94/28034, for example. As additive, it is possible to add, during or after the production of the carrier-supported catalyst system, a small quantity of an olefin, preferably an α-olefin, (e.g. vinylcyclohexane, styrene or phenyl dimethylvinylsilane) as modifying component or an antistatic agent (as described in U.S. Ser. No. 08/365,280). The molar ratio of additive to the compound of formula (I) is preferably between 1:1000 and 1000:1, particularly preferably 1:20 to 20:1.

The present invention also relates to a method for the production of a polyolefin by the polymerisation of one or several olefins in the presence of the catalyst system according to the invention. The term polymerisation should be understood to mean homopolymerisation as well as copolymerisation.

Preferably, olefins with the formula Rₘ—CH═CH—Rₙ are polymerised, in which Rₘ and Rₙ are the same or different and represent a hydrogen atom or a carbon-containing radical with 1 to 20 C atoms, in particular 1 bis 10 C atoms, and Rₘ and Rₙ may form one or several rings together with-the atoms linking them.

Examples of such olefins are 1-olefin with 2-20, preferably 2 to 10 C atoms such as ethene, propene, 1-butene, 1-pentene, 1-hexene, 4-methyl-1-pentene or 1-octene, styrene, dienes such as 1,3-butadiene, 1,4-hexadiene, vinylnorbornene, norbornadiene, ethylnorbornadiene and cyclic olefins such as norbornene, tetracyclododecene or methylnorbornene. In the process according to the invention, ethene or propene are preferably homopolymerised or propene is copolymerised with ethene and/or with one or several 1-olefins with 4 to 20 C atoms such as butene, hexene, styrene or vinylcyclohexane and/or one or several dienes with 4 to 20 C atoms such as 1,4-butadiene, norbornadiene, ethylidene norbonene or ethyinorbornadiene. Examples of such copolymers are ethene-propene copolymers, ethene-norbornene, ethene-styrene or ethene-propene-1,4-hexadiene terpolymers. The polymerisation is carried out at a temperature of 0 to 300° C., preferably 50 to 200° C., particularly preferably 50-80° C. The pressure is 0.5 to 2000 bar, preferably 5 to 64 bar.

The polymerisation may be carried out in solution, in bulk, in suspension or in the gaseous phase, continuously or batchwise, as a single or multiple stage. The catalyst system prepared according to the invention may be used as the sole catalyst component for the polymerisation of olefins with 2 to 20 C atoms or preferably in combination with at least one alkyl compound from the elements of the main group I to III of the periodic system such as e.g. an aluminium, magnesium or lithium alkyl or an aluminoxane. The alkyl compound is added to the monomer or suspension agent and is used to purify the monomer of substances which might negatively affect the catalyst activity. The quantity of alkyl compound added depends on the quality of the monomers used. If necessary, hydrogen is added as a molecular weight control and/or to increase the activity.

The catalyst system may be added to the polymerisation system in the pure state or, for better ease of metering, it may be mixed with inert components such as paraffins, oils or waxes. During the polymerisation, it is also possible to add an antistatic agent together with or separately from the catalyst system to the polymerisation system in a controlled manner.

The polymers prepared with the catalyst system according to the invention exhibit a homogeneous grain morphology and contain no fine grained fractions. During polymerisation with the catalyst system according to the invention, no deposits or caking takes place.

The invention is illustrated by the following examples which, however, do not restrict the invention.

General information: The manufacture and handling of the organonietallic compounds takes place with the exclusion of air and moisture-under argon blanketing (Schlenk technique or glove box). All the solvents required were flushed with argon before use and rendered absolute on molecular sieve.

1. Preparation of the Ligands

### EXAMPLE 1

### Preparation of N,N′-2-methylbenzimidazolyl methane

0.478 g (2.1 mmole) triethylbenzylammonium chloride, 6.0 g (43.41 mmole) and 3 g (53.47 mmole) potassium hydroxide are added to a solution of 5.61 g (42.48 mmole) 2-methylbenzimidazole in 140 ml dichloromethane. This reaction mixture is refluxed for a hours. Subsequently, it is stirred over night at room temperature. The insoluble residue is separated off via a G3 sintered glass filter and the filtrate is dried over magnesium sulphate. After removing the solvent, the product was isolated in a yield of 6.52 g in the form of a white powder. ¹H-NMR(CDCl₃): 7.6-6.9 (m, 8H; Aromat-H), 6.25 (s, 2H, CH₂—H), 2.5 (s, 6H, CH₃—H) ppm.

### EXAMPLE 2

### Preparation of N,N′,N″-benzotriazole methane

0.756 g (3.32 mmole) triethylbenzylammonium chloride, 4.73 g (34.25 mmole) and 2.37 g (42.31 mmole) potassium hydroxide are added to a solution of 4.0 g (33.58 mmole) benzotriazole in 120 ml dichloromethane. This reaction mixture is refluxed for 12 hours. Subsequently, it is stirred over night at room temperature. The insoluble residue is separated off via a G3 sintered glass filter and the filtrate is dried over magnesium sulphate. After removing the solvent, the product was isolated in a yield of 4.54 g in the form of a yellow powder. ¹H-NMR(CDCl₃): 7.6-6.9 (m, 8H, Aromat-H), 6.47 (s, 2H, CH₂—H); ppm. :

### EXAMPLE 3

### 1,2-bis-(N,N′-benzimidazolyl) ethane

A solution of 85 g NaOH in 170 ml water is added to 20.0 g (169 mmole) benzimidazole and stirred for 30 minutes at 50° C. Subsequently, 3.4 g (10 mmole) tetrabutylammonium bromide and 16.1 g (85 mmole) 1-2-dibromomethane are added and stirred for 30 minuets at 50° C. A precipitate is formed after 2 h. The suspension is stirred over night at room temperature and then stored for 3 hours at 4° C. The precipitate thus obtained is filtered off and stirred with ethanol. The product is obtained by filtration as a white powder in a yield of 4.9 g (19 mmole, 23%) ¹H-NMR(CDCl₃): 7.9 (s, 2H, olefin, H), 7.4-6.9 (m, 8H, Aromat-H), 4.6 (s, 4H, CH₂CH₂) ppm.

### EXAMPLE 4

### 1,2-bis-(N,N′-2,3-dihydro-1H-benzimidazolyl) ethane

3.8 ml (3.8 mmole, 1.0M in THF) are added dropwise within 15 minutes to 1 g (3.8 mmole) 1,2-bis-(N,N′-benzimidazolyl)ethane in 36 ml THF. Stirring is continued for 2 h at room temperature and 30 ml of a saturated NH₄Cl solution are then carefully added. The phases are separated and the aqueous phase is extracted 3× with 50 ml diethylether each. The combined organic phases are dried over MgSO4 and the solvent is removed under vacuum, giving the product in a yield of 0.98 g (3.7 mmole, 97%) in the form of a light yellow oil. ¹H-NMR (CDCl₃): 6.5-6.2 (m, 8H, aromat. H), 4.7 (s, 8H, CH₂CH₂), 4.0 (s, br, 2H, NH), 3.3 (s, 4H, CH₂) ppm.

### EXAMPLE 5

### 1,2-bis-(N,N′-2-methylbenzimidazolyl) ethane

A solution of 38 g NaOH in 76 ml water is added to 10.0 g (76 mmole) 2-mehtylbenzimidazole and stirred for 30 minutes at 50° C. Subsequently, 1.5 g (5 mmole) tetrabutylammonium bromide and 7.1 g (38 mmole) 1,2-dibromomethane are added and stirred for 30 minutes at 50° C. A precipitate is formed after 5 h. The suspension is stirred over night at room temperature and then stored for 3 hours at 4° C. The precipitate thus obtained is filtered off and stirred with ethanol. The product is obtained by filtration as a white powder in a yield of 2.4 g (8.3 mmole, 22%). ¹H-NMR(CDCl₃): 7.7-7.2 (m, 8H, Aromat-H), 4.3 (s, 4H, CH₂CH₂), 2.4 (s, 6H, CH₃) ppm.

2. Preparation of the Complexes

### EXAMPLE 6

### Preparation of methylene bis(N,N′-2-methylbenzimidazolyl)nickel dibromide

250 mg (0.905 mmole) N,N′-2-methylbenzimidazolyl methane are placed into 15 ml THF and 279 mg (0.905 mmole) nickel dibromide*DME are added batchwise at room temperature. Stirring at this temperature is carried out over night. The blue precipitate obtained is isolated on a G4 sintered glass filter and washed twice with 5 ml THF each. The desired Ni complex is isolated in-a yield of 360 mg.

### EXAMPLE 7

### Preparation of methylene bis(N,N′-2-methylbenzimidazolyl)iron dichloride

250 mg (0.905 mmole) N,N′-2-methylbenzimidazolyl methane are placed into 15 ml THF and 114 mg (0.905 mmole) iron(II)chloride are added batchwise at room temperature; Stirring is continued At this temperature over night. The precipitate obtained is isolated on a G4 sintered glass filter and washed twice with 5 ml THF respectively. The desired Fe complex is isolated in a yield of 300 mg.

### EXAMPLE 8

### Preparation of methylene bis(N,N′-2-methylbenzimidazolyl)palladium dichloride

250 mg (0.923 mmole) N,N′-2-methylbenzimidazolyl methane are placed into 15 ml THF and 212 mg (0.924 mmole) palladium dichloride acetonitrile complex are added batchwise at room temperature. Stirring is continued at this temperature for 2 hours. The precipitate obtained is isolated on a G4 sintered glass filter and washed twice with 5 ml THF respectively. The desired Pd complex is isolated in a yield of 210 mg.

### EXAMPLE 9

### Preparation of methylene bis(N,N′-2-methylbenzotriazolyl)nickel dibromide

250 mg (0.999 mmole) N,N′-benzotriazole methane are placed into 12 ml THF and 308 mg (0.905 mmole) nickel dibromide*DME are added batchwise at room temperature. Stirring is continued at this temperature over night. The precipitate obtained is isolated on a G4 sintered glass filter and washed twice with 5 ml THF respectively. The desired Ni complex is isolated in a yield of 380 mg.

### EXAMPLE 10

### Ethylene bis-(N,N′-benzimidazolyl)nickel dibromide

300 mg (1.14 mmole) 1,2-bis-(N,N′-benzimidazolyl) ethane are placed into 20 ml THF and 353 mg (1-14 mmole) nickel dibromide*DME are added batchwise at room temperature. Stirring is continued at this temperature over night. The blue precipitate obtained is isolated on a G4 sintered glass filter and washed twice with 5 ml THF respectively. The desired Ni complex is isolated in a yield of 335 mg.

### EXAMPLE 11

### Ethylene bis-(N,N′-benzimidazolyl)iron dichloride

300 mg (1.14 mmole) 1,2-bis-(N,N′-benzimidazolyl) ethane are placed into 20 ml THF and 145 mg (1.14 mmole) iron(II)chloride (anhydrous) are added batchwise at room temperature. Stirring is continued at this temperature over night. The grey precipitate obtained is isolated on a G4 sintered glass filter and washed twice with 5 ml THF respectively. The desired Fe complex is isolated in a yield of 295 mg.

### EXAMPLE 12

### Ethylene bis-(N,N′-benzimidazolyl)palladium dichloride

300 mg (1.14 mmole) 1,2-bis-(N,N′-benzimidazolyl) ethane are placed into 20 ml THF and 296 mg (1.14 mmole) bisacetonitrile palladium dichloride are added batchwise at room temperature. Stirring is continued for 2 h at this temperature. The precipitate obtained is isolated on a G4 sintered glass filter and washed twice with 5 ml THF respectively. The desired Pd complex is isolated in a yield of 320 mg.

### EXAMPLE 13

### Ethylene bis-(N,N′-2-methylbenzimidazolyl)nickel dibromide

300 mg (1.03 mmole) 1,2-bis-(N,N′-benzimidazolyl) ethane are placed into 20 ml THF and 319 mg (1.03 mmole) nickel dibromide*DME are added batchwise at room temperature. Stirring is continued at this temperature over night. The blue precipitate obtained is isolated on a G4 sintered glass filter and washed twice with 5 ml THF respectively. The desired Ni complex is isolated in a yield of 322 mg.

### Example 14

### Ethylene-bis-(N,N′-2-methylbenzimidazolyl)iron dichloride

300 mg (1.03 mmole) 1,2-bis-(N,N′-benzimidazolyl) ethane are placed into 20 ml THF and 131 mg (1.03 mmole) iron(II)chloride (anhydrous) are added batchwise at room temperature. Stirring is continued at this temperature over night. The grey precipitate obtained is isolated on a G4 sintered glass filter and washed twice with 5 ml THF respectively. The desired Fe complex is isolated in a yield of 273 mg.

### EXAMPLE 15

### Ethylene bis-(N,N′-2-methylbenzimidazolyl)-palladium dichloride

300 mg (1.03 mmole) 1,2-bis-(N,N′-2-methylbenzimidazolyl) ethane are placed into 20 ml THF and 286 mg (1.03 mmole) bisacetonitrile palladium dichloride are added batchwise at room temperature. Stirring is continued for 2 h at this temperature. The precipitate obtained is isolated on a G4 sintered glass filter and washed twice with 5 ml THF respectively. The desired Pd complex is isolated in a yield of 304 mg.

### EXAMPLE 16

### Ethylene bis-(N,N′-2,3-dihydro-1H-benzimidazolyl)zirconium dichloride

500 mg (1.9 mmole) 1,2-bis-(N,N′-benzimidazolyl) ethane are placed into 5 ml toluene/THF (10:1). At 0° C., 3.8 ml (3.8 mmole, 1.0M in toluene) n-BuLi are added dropwise within 5 minutes. Stirring is carried out for 0.5 h at 0° C. and 1 h at room temperature. Subsequently, cooling to −78° C. takes place and 442 mg (1.9 mmole) zirconium tetrachloride are added. After heating to room temperature, stirring is continued for 3 hours and the solvent is then removed under vacuum. The residue is stirred with 10 ml toluene and the lithium chloride precipitated out is separated off by filtration over Celite. The Celite is washed a further 3 times with 10 ml of toluene heated to 80° C. The filtrate is strongly concentrated and stored for 12 hours at 4° C. The desired Zr complex is isolated by filtration on a G4 sintered glass filter in a yield of 243 mg in the form of a light grey powder. ¹H-NMR (CDCl₃) [rac & meso]: 8.6-8.4 (m, 4H, CH₂,), 7.9-7.1 (m, 8H, Aromat), 4.9-4.6 (m, 4H, CH₂CH₂) ppm.

### EXAMPLE 17

### Ethylene bis-(N,N′-2,3-dihydro-1H-benzimidazolyl)titanium dichloride

500 mg (1.9 mmole) 1,2-bis-(N,N′-benzimidazolyl) ethane are placed into 5 ml toluene/THF (10:1). At 0° C., 3.8 ml (3.8 mmole, 1.0M in toluene) n-BuLi are added dropwise within 5 minutes. Stirring is carried out for 0.5 h at 0° C. and 1 h at room temperature. Subsequently, cooling to −78° C. takes place and 171 mg (1.9 mmole) titanium tetrachloride are added dropwise within 5 min. After heating to room temperature, stirring is continued for 3 hours and the solvent is then removed under vacuum. The residue is stirred with 10 ml toluene and the lithium chloride precipitated out is separated off by filtration over Celite. The Celite is washed a further 3 times with 10 ml of toluene heated to 80° C. The filtrate is strongly concentrated and stored for 12 hours at 4° C. The desired Ti complex is isolated by filtration on a G4 sintered glass filter in a yield of 243 mg in the form of a light brown powder. ¹H-NMR (CDCl₃) [rac & meso]: 8.7-8.4 (m, 4H, CH₂,), 7.8-7.0 (m, 8H, Aromat), 5.1-4.7 (m, 4H, CH₂CH₂) ppm.

### EXAMPLE 18

### Ethylene bis-(N,N′-2,3-dihydro-2,2-dimethyl-1H-benzimidazolyl) zirconium dichloride

500 mg (1.7 mmole) 1,2-bis-(N,N′-2-methylbenzimidazolyl) ethane are placed into 10 ml THF. At −78° C., 3.4 ml (3.4 mmole, 1.0M in diethylether) methyllithium are added dropwise. After heating to room temperature, stirring is carried out for 15 min and renewed cooling to −78° C. 396 mg (1.7 mmole) zirconium tetrachloride are added. After heating to room temperature, stirring is continued for 3 hours and the solvent is then removed under vacuum. The residue is stirred with 10 ml toluene and the lithium chloride precipitated out is separated off by filtration over Celite. The Celite is washed a further 3 times with 10 ml of toluene heated to 80° C. The filtrate is strongly concentrated and stored for 12 hours at 4° C. The desired Zr complex is isolated by filtration on a G4 sintered glass filter in a yield of 342 mg in the form of a light grey powder. ¹H-NMR (CDCl₃) [rac & meso]: 7.8-7.2 (m, 8H, Aromat), 4.9-4.6 (m, 4H, CH₂CH₂) 3.3-3.1 (m, 12H, CH₃) ppm.

### BEIPIEL 19

### Ethylene bis-(N,N′-2,3-dihydro-2,2-dimethyl-1H-benzimidazolyl) titanium dichloride

500 mg (1.7 mmole) 1,2-bis-(N,N′-2-methylbenzimidazolyl) ethane are placed into 10 ml THF (10:1). At −78° C., 3.4 ml (3.4 mmole, 1.0M in diethylether) methyllithium are added dropwise. After heating to room temperature, stirring is carried out for 15 min and renewed cooling −78° C. 322 mg (1.7 mmole).titanium tetrachloride are added dropwise within 5 min. After heating to room temperature, stirring is continued for 3 hours and the solvent is then removed under vacuum. The residue is stirred with 10 ml toluene and the lithium chloride precipitated out is separated off by filtration over Celite. The Celite is washed a further 3 times with 10 ml of toluene heated to 80° C. The filtrate is strongly concentrated and stored for 12 hours at 4° C. The desired Ti complex is isolated by filtration on a G4 sintered glass filter in a yield of 289 mg in the form of a light brown, powder. ¹H-NMR (CDCl₃) [rac & meso]: 7.9-7.3 (m, 8H, Aromat), 4.8-4.5.(m, 4H, CH₂CH₂) 3.4-3.2 (m, 12H, CH₃) ppm.

1. Compounds of formula (I) 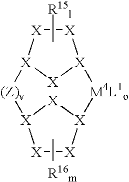
wherein
M⁴ is a metal of group III to XII of the periodic system of elements
R¹⁵, R¹⁶, respectively, are the same or different and represent a hydrogen atom or Si(R¹²)₃, R¹² representing in the same way or differently a hydrogen atom or a C₁-C₄₀—carbon-containing group
or R¹⁵, R¹⁶, respectively, are the same or different and represent a C₁-C₃₀—carbon-containing group
or two or more R¹⁵ or R¹⁶ radicals may be connected such that the R¹⁵ or R¹⁶ radicals and the atoms of the five-membered ring connecting them from a C₄-C₂₄ ring system which may in turn be substituted,
I may be a number between 0 and 8 for v=0, depending on the valency of the X atom, and a number between 0 and 7 for v=1, depending on the valency of the X atom,
m may be a number between 0 and 8 for v=0, depending on the valency of the X atom, and a number between 0 and 7 for v=1, depending on the valency of the X atom,
X may be the same and different and be an element of groups 13-16 of the periodic system of elements which in turn may be substituted by R¹⁵ or R¹⁶, at least one X being B, Si, N, O, S, or P,
L may be the same or different and represent a hydrogen atom, a C₁-C₁₀ hydrocarbon group, a halogen atom or OR⁹, SR⁹, OSi(R⁹)₃, Si(R⁹)₃, P(R⁹)₂ or N(R⁹)₂, in which R⁹ are a halogen atom, a C₁-C₁₀ alkyl group, halogenated C₁-C₁₀ alkyl group, a C₆-C₂₀ aryl group or a halogenated C₆-C₂₀ aryl group,
o is an integer of 1 to 4, and
Z represents a bridging structural element between the two cyclopentadienyl rings and v is 0 or 1.

2. Compounds according to claim 1 wherein Z represents a M²R¹⁰OR¹¹ group in which M² represents carbon, silicon, germanium, boron or tin and R¹⁰ and R¹¹ represent in the same way or differently a C₁-C₂₀ hydrocarbon-containing group.

3. Compounds according to claim 1 wherein Z is selected from the group consisting of CH₂, CH₂,CH₂, CH(CH₃)CH₂, CH(C₄H₉)C(CH₃)₂, C(CH₃)₂, (CH₃)₂Si, (CH₃)₂Ge, (CH₃)₂Sn, (C₆H₅)₂Si, (C₆H₅)(CH₃)Si, (C₆H₅)₂Ge, (CH₃)₃Si—Si(CH₃), (C₆H₅)₂Sn, (CH₂)₄Si, CH₂Si(CH₃)₂, o-C₆H₄ or 2,2′-(C₆H₄)₂, as 1,2-(1-methyl ethanediyl), 1,2-(1,1-dimethyl ethandiyl), and 1,2-(1,2-dimethyl ethanediyl).

4. Compounds according to claim 1 wherein M⁴ is selected from the group consisting of Ti, Zr, Hf, Ni, V, W, Mn, Rh, Ir, Cu, Co, Fe, Pd, Sc, Cr, and Nb.

5. Compounds according to claim 1 wherein X represents a —CR-radical, R, respectively, representing independently from each other hydrogen or a C₁-C₄₀ carbon-containing group, or two or several R radicals may be connected such that the R radicals and the atoms of the five-membered ring connecting them form a C₄-C₂₄ ring system which in turn may be substituted, with the proviso that at least one X radical is en B, Si, N, O, S, or P.

6. Compounds of formula (II), 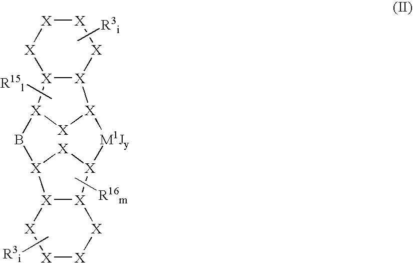
wherein
R¹⁵, R¹⁶, X are defined as in claim 1
M¹ is selected from the group consisting of Ni, Pd, Co, Fe, Ti, Zr, and Hf;
R³ respectively, are the same or different and represent a hydrogen atom, O—Si(R¹²)₃ or Si(R¹²)₃ in which R¹², respectively, represent in the same way or differently a hydrogen atom or a C₁-C₄₀ carbon-containing group or R³, respectively, are the same or different and represent a C₁-C₃₀ carbon-containing group
or two or more R³ radicals may be connected such that the R³ radicals and the atoms connecting them form a C₄-C₂₄ ring system which in turn may be substituted,
J is, independently from each other, a halogen atom, alkyl groups or substituted or unsubstituted phenolates.
i respectively, represent in the same way of differently an integer between 1 and 8, depending on the valency of the X atom,
B represents a bridging structural element between the two cyclic systems,
l is an integer of 1 to 5, depending on the valency of the X atom,
m is an integer of 1 to 5, depending on the valency of the X atom, and,
y is an integer of 1 to 4.

7. Compounds according to claim 6 wherein the ring system is substituted by R³, R¹⁵ or R¹⁶.

8. Catalyst system containing at least one compound according to claim 1 and at least one co-catalyst.

9. Catalyst system according to claim 8 wherein the co-catalyst is selected from the group consisting of aluminoxane, Lewis acids, and ionic compounds that convert the compound according to of claim 1 into a cationic compound.

10. Catalyst system according to claim 8 further comprising at least one carrier.

11. (canceled)

12. (canceled)

13. Process for the production of polyolefins comprising the step of polymerizing at least one olefin in the presence of a catalyst system according to claim 8.

14. Compounds according to claim 5, wherein R is selected from the group consisting of C₁-C₂₀ alkyl, C₁-C₁₀ fluoroalkyl, C₁-C₁₀ alkoxy, C₆-C₂₄ aryl, fluorine-containing C₆-C₂₄-aryl, C₅-C₂₄ heteroaryl, C₆-C₁₀ fluoroaryl, C₆-C₁₀ aryloxy, C₂-C₂₅ alkenyl, C₃-C₁₅ alkylalkenyl, C₇-C₄₀ arylalkyl, fluorine-containing C₇-C₃₀ arylalkyl, C₇-C₄₀ alkylaryl, fluorine-containing C₇-C₃₀ alkylaryl, and C₈-C₄₀ arylalkenyl.

15. Compounds according to claim 14, wherein R is selected from the group consisting of methyl, ethyl, tert.-butyl,-n-hexyl, cyclohexyl, and octyl groups.

16. Compounds according to claim 6, wherein J is chlorine.

17. Compounds according to claim 6, wherein J is a C₁-C₁₈ alkyl group.

18. Compounds according to claim 17, wherein J is selected from the group consisting of methyl, ethyl, and tert.-butyl.

19. Compounds according to claim 7, wherein the ring system is substituted by R³, R¹⁵, or R¹⁶ at (a) position 2,4,7, or (b) position 2,4,5, or (c) position 2,4,6, or (d) position 2,4,7,2, or (e) position 4,5,6,7, or (f) position 2,4,5,6.

20. Process of claim 13, comprising the step of homopolymerizating an olefin.

21. Process of claim 13, comprising the step of copolymerizing at least two olefins.
